(19) United States
(12) Patent Application Publication
(10) Pub. No.: US 2013/0073317 A1
(43) Pub. Date: Mar. 21, 2013

(54) PERSONAL DATA ARCHIVAL, STORAGE, RETRIEVAL AND REPLACEMENT INSURANCE POLICY

(71) Applicant: PAMELA JONETTE WILLIAMS, ARLINGTON, TX (US)

(72) Inventor: PAMELA JONETTE WILLIAMS, ARLINGTON, TX (US)

(73) Assignee: PAMELA JONETTE WILLIAMS, ARLINGTON, TX (US)

(21) Appl. No.: 13/233,244

(22) Filed: Sep. 15, 2011

(51) Int. Cl. G06Q 40/00

(52) U.S. Cl. 705/4

(57) ABSTRACT

The recent increase of natural disasters makes us all very mindful of what is really important. Our loved ones, our homes, our cherished memories are at the top of that list. This invention insures and protects personal photographs, digital media and personal documents with an archival, storage, retrieval and replacement system. Insureds' personal data is scanned using professional photographic scanning equipment to capture optimal image resolution. All data is encrypted with military-grade encryption prior to transfer via a secure SSL connection. Data is stored in state-of-the-art data centers that employ the highest security standards and are SAS70 or ISO certified.

Once the data has been stored, the original images and data files are returned to the insured to enjoy. In the event of a loss, the insured files a claim and upon payment of the policy deductible, the data is retrieved and replaced.

Various provisions in this policy restrict coverage. Read the entire policy carefully to determine rights, duties and what is and is not covered.

Throughout this policy the words “you” and “your” refer to the Insured shown in the Declarations, and any other person qualifying as the Insured under this policy. The words “we”, “us” and “our” refer to the company providing this insurance.

The word “insured” means any person qualifying as such under Section II—Who Is An Insured.

### Section I—Coverages Coverage of Personal Photographs, Digital Media and Documents

### 1. Insuring Agreement

a. Coverage Provider will indemnify the insured, in excess of the deductible, for direct physical loss or damage to the photographs, digital media, and/or personal documents submitted to Coverage Provider and listed in the attached catalogue. Only data listed in the catalogue is covered under this policy.
b. All photographs and personal documents are scanned using professional photographic scanning equipment to capture optimal image resolution. All data is encrypted with military-grade encryption prior to transfer via a secure SSL connection. Data is stored in state-of-the-art data centers that employ the highest security standards and are SAS70 or ISO certified.
c. Upon notice to Coverage Provider of an incident or event in which the covered images are damaged or destroyed, and payment of the deductible, Coverage Provider will provide retrieval and replacement of the insured images.
d. Following initial data archival and storage, additional data may be added to the policy coverage on an annual basis; one month prior to one month following the anniversary renewal date. Additional premiums may be required.

### Section II—Who is an Insured

### 1. If you are Designated in the Declarations as the INSURED.

a. If you are designated in the Declarations as:
An individual, you and your spouse are the Insureds.
b. In the event of the insurer's death, the rights of this policy may be transferred to the legal representative of the insured.

### Section III—Policy Term

The term of this policy is one year from the date of execution. The policy automatically renews on the anniversary date each and every year unless cancelled by the insured or Coverage Provider. The insured is responsible for the payment of all annual premiums.

### Section IV—Cancellation

1. The Insured shown in the Declarations may cancel this policy by mailing or delivering to Coverage Provider advance written notice of cancellation.
2. Coverage Provider may cancel this policy by mailing or delivering to the insured written notice of cancellation at least:
a. 10 days before the effective date of cancellation if we cancel for nonpayment of premium; or
b. 30 days before the effective date of cancellation if we cancel for any other reason.
   3. We will mail or deliver our notice to the insured's last mailing address known to Coverage Provider.
   4. Notice of cancellation will state the effective date of cancellation. the policy period will end on that date.
   5. If Notice is mailed, proof of mailing will be sufficient proof of notice.
   6. If the Insured cancels, Coverage Provider will destroy all data archived and stored. If Coverage Provider cancels, the data will be retained for 30 days following the effective date of the cancellation.

1. Worldwide personal data archival, storage, retrieval and replacement insurance to protect insureds against damage or loss of personal photographs, digital media, and personal documents resulting from catastrophic events such as flood, fire, tornado, hurricane, earthquake, tsunami, windstorm, theft or terroristic act.

2. The insurance coverage described in claim 1 has premiums priced and regulated by the Insurance Commission of each applicable jurisdiction.

3. The insurance coverage described in claim 1 has a policy deductible for retrieval of insured data upon filing a claim as regulated by the Insurance Commission of each applicable jurisdiction.

4. The insurance coverage described in claim 1 has a one year term renewable on the anniversary date each year and every year unless cancelled by the insured or the policy writer.

5. All data insured under claim 1 is submitted by the insured to the Coverage Provider's processing for scanning and storage. Once scanning and storage is completed, the data is returned to the insured with documentation of the data submitted. Only the data documented will be covered under the insurance coverage described in claim 1.

6. Upon notice to Coverage Provider of a covered incident or event in which the covered images are damaged or destroyed, and payment of the deductible, Coverage Provider will provide retrieval and replacement of the insured images.

7. Policyholders have the option to add additional data on an annual basis.

8. In the event of the insured's death, the rights of the insurance coverage described in claim 1 may be transferred to the legal representative of the insured.
